(19) United States
(12) Patent Application Publication
(10) Pub. No.: US 2009/0232425 A1
(43) Pub. Date: Sep. 17, 2009

(54) Flexible Tubular Packaging Bag and Method and Apparatus for Making the Same

(76) Inventors: Jung-Chi Tai, Tainan Hsien (TW); Ho-Hsi Yang, Tainan Hsien (TW); Kuo-Li Lin, Tainan Hsien (TW); Chun-Meng Huang, Tainan Hsien (TW); Chien-Chung Su, Tainan Hsien (TW)

Correspondence Address: FROMMER LAWRENCE & HAUG LLP, 745 FIFTH AVENUE, NEW YORK, NY, 10151, US

(21) Appl. No.: 12/171,786

(22) Filed: Jul. 11, 2008

(30) Foreign Application Priority Data
Mar. 17, 2008 (TW) 097109315

(51) Int. Cl. B65D 33/16; B65D 33/01; B31B 1/00; B31B 1/64; B31B 1/16

(52) U.S. Cl. 383/211; 383/103; 493/267; 493/189; 493/239

(57) ABSTRACT

An individual flexible tubular packaging bag for sanitary products includes a flexible bag body made from a flexible seamless tubular body of a heat-weldable material by heat-sealing two opposite ends of the seamless tubular body. The flexible bag body defines a receiving space that is adapted to receive the sanitary products, and has an access opening in spatial communication with the receiving space. A resealable flap is connected to the flexible bag body, and seals openably the access opening.

### CROSS-REFERENCE TO RELATED APPLICATION

This application claims priority of Taiwanese Application No. 097109315, filed on Mar. 17, 2008.

### BACKGROUND OF THE INVENTION

1. Field of the Invention

This invention relates to a flexible tubular packaging bag, more particularly to a flexible tubular packaging bag for sanitary products and a method and apparatus for making the same.

2. Description of the Related Art

Referring to FIGS. 1 to 3, a conventional flexible tubular packaging bag 1 for sanitary products is made by preparing a bag body 11 which is in the form of a flat sheet and which has an access opening 111. Left and right sides of the bag body 11 are folded toward each other, as shown by the arrows in FIG. 2, through a folding device (not shown), and are sealed together through a sealing device (not shown) so as to form a tubular body 11′ having a sealing portion 112 that extends from a front end 114 to a rear end 113 thereof. Subsequently, the rear end 113 of the tubular body 11′ is sealed, the sanitary products (not shown) are disposed inside the tubular body 11′ through the front end 114 thereof, and the front end 114 is sealed. A resealable flap 12 is then adhered manually to the tubular body 11′ so as to close openably the access opening 111.

In use, the resealable flap 12 is pulled open at one side so as to reveal the access opening 111, and one of the sanitary products can be taken out from the tubular packaging bag 1. The resealable flap 12 is resealed so as to close the access opening 111, thereby preventing contamination of the remaining sanitary products in the tubular packaging bag 1. Since the folding device is needed to fold the left and right sides of the flat sheet of the bag body 11 during manufacture of the tubular packaging bag 1, the method for making the conventional flexible tubular packaging bag 1 is complicated. Further, the adhering operation of the resealable flap 12 is done manually, so that the production of the conventional tubular packaging bag 1 is not only slow, but the cost thereof is also increased.

### SUMMARY OF THE INVENTION

Therefore, an object of the present invention is to provide a method for making a flexible tubular packaging bag that has a resealable flap which can be adhered automatically to the flexible tubular packaging bag.

Another object of the present invention is to provide a system for making a flexible tubular packaging bag that has a resealable flap which can be adhered automatically to the flexible tubular packaging bag.

Still another object of the present invention is to provide a flexible tubular packaging bag having a resealable flap which can be adhered automatically to the flexible tubular packaging bag.

According to one aspect of this invention, an individual flexible tubular packaging bag for sanitary products comprises a flexible bag body and a resealable flap. The flexible bag body is made from a flexible seamless tubular body of a heat-weldable material by heat-sealing two opposite ends of the seamless tubular body. The flexible bag body defines a receiving space that is adapted to receive the sanitary products, and has an access opening in spatial communication with the receiving space. The resealable flap is connected to the flexible bag body, and seals openably the access opening.

According to another aspect of this invention, a method for making flexible tubular packaging bags for sanitary products comprises the steps of: (A) providing a strip of a flexible seamless tubular body of a heat-weldable material, the strip of the flexible seamless tubular body having a plurality of access openings spaced apart from each other and aligned along the length of the strip; (B) sealing openably and respectively the access openings with resealable flaps; (C) heat-sealing the seamless tubular body at a position between two adjacent ones of the resealable flaps so as to form a sealing portion therebetween; and (D) cutting the seamless tubular body along a cutting line between each two adjacent ones of the resealable flaps, thereby obtaining semi-finished individual flexible bag bodies, each of which has an open end, and a sealed end opposite to the open end and defined by the sealing portion.

According to still another aspect of this invention, a system for making flexible tubular packaging bags for sanitary products comprises a supplying roller, a conveying device, a label-adhering device, a sealing device, and a cutting device. The supplying roller holds a strip of a flexible seamless tubular body of a heat-weldable material. The strip of the flexible seamless tubular body has a plurality of access openings spaced apart from each other and aligned along the length of the strip. The conveying device is used to convey the strip of the seamless tubular body supplied by the supplying roller. The label-adhering device includes a roll of resealable flaps, and affixes each of the resealable flaps over a respective one of the access openings so as to seal openably the respective one of the access openings. The sealing device is disposed downstream of the label-adhering device, and heat-seals the strip of the seamless tubular body at a position between two adjacent ones of the resealable flaps so as to form a sealing portion therebetween. The cutting device is disposed downstream of the sealing device, and cuts the strip of the seamless tubular body along a cutting line between each two adjacent ones of the resealable flaps so as to form semi-finished individual flexible bag bodies, each of the which has an open end, and a sealed end opposite to the open end and defined by the sealing portion.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional flexible tubular packaging bag;

FIG. 2 is a perspective view of a bag body used in the making of the conventional flexible tubular packaging bag;

FIG. 3 is another perspective view of the conventional flexible tubular packaging bag;

FIG. 4 is a perspective view of a flexible tubular packaging bag according to the preferred embodiment of the present invention;

FIG. 5 is a view similar to FIG. 4, but illustrating a resealable flap being pulled open to reveal an access opening;

FIG. 6 is another perspective view of the flexible tubular packaging bag of the present invention;

FIG. 7 is a flowchart, illustrating the steps involved in making the flexible tubular packaging bag of the present invention;

FIG. 8 is a schematic view of a system for making the flexible tubular packaging bag of the present invention;

FIG. 9 is a fragmentary schematic view of the preferred embodiment, illustrating a supplying roller supplying a strip of a flexible seamless tubular body;

FIG. 10 is a sectional view of the seamless tubular body;

FIG. 11 is a fragmentary schematic view of the preferred embodiment, illustrating how a resealable flap is attached to the seamless tubular body by a label-adhering device;

FIG. 12 is a fragmentary schematic view of the preferred embodiment, illustrating a punching device punching vent holes in the seamless tubular body; and

FIG. 13 is a fragmentary schematic view of the preferred embodiment, illustrating how a semi-finished individual flexible bag body is obtained.

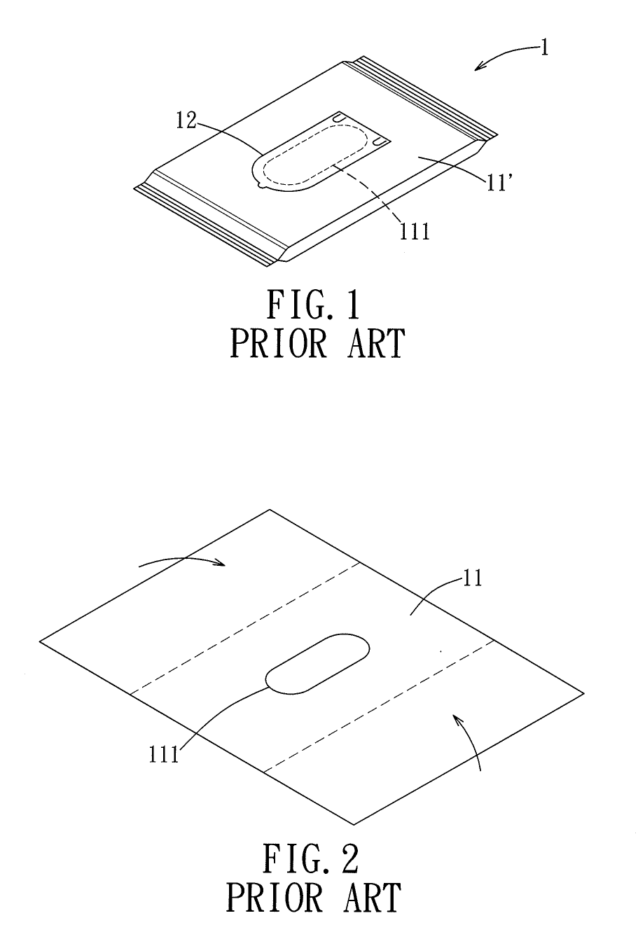

### DETAILED DESCRIPTION OF THE PREFERRED EMBODIMENT

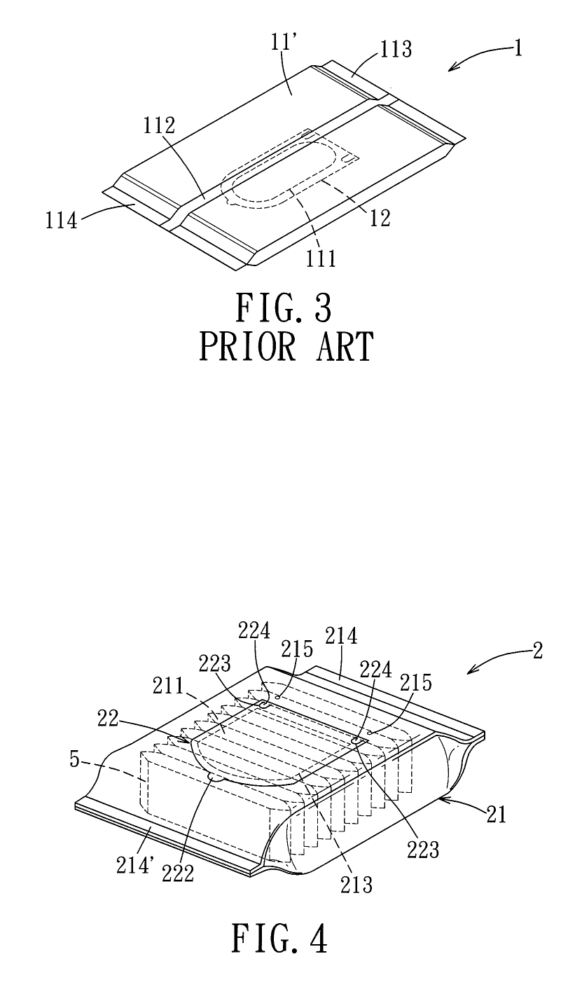

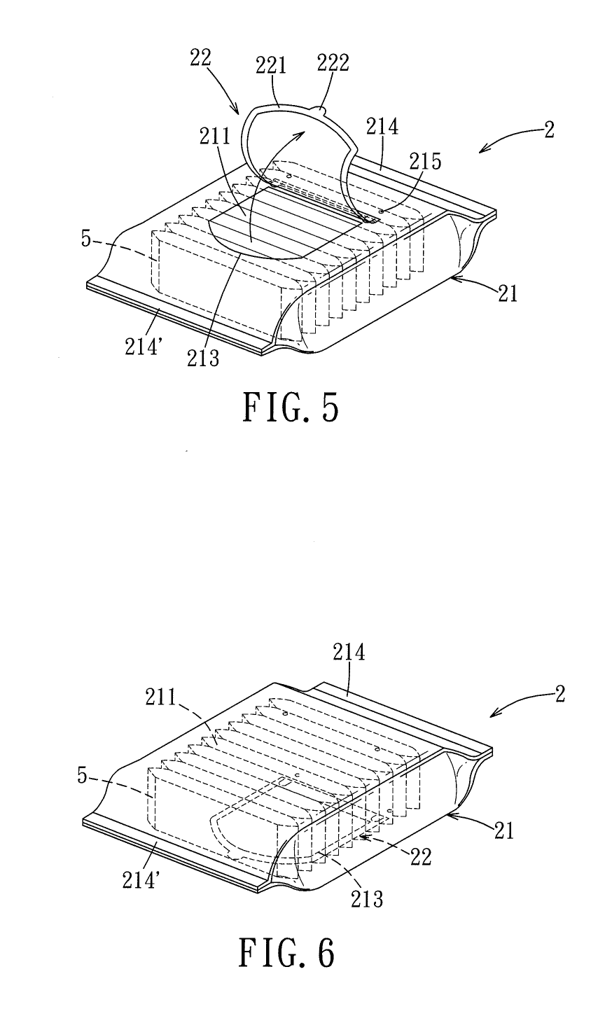

Referring to FIGS. 4 to 6, an individual flexible tubular packaging bag 2 according to the preferred embodiment of the present invention is shown to comprise a flexible bag body 21 and a resealable flap 22. In this embodiment, the tubular packaging bag 2 is adapted to contain sanitary products 5, such as sanitary napkins, panty shields, or diapers, and may be made of plastic or aluminum foil.

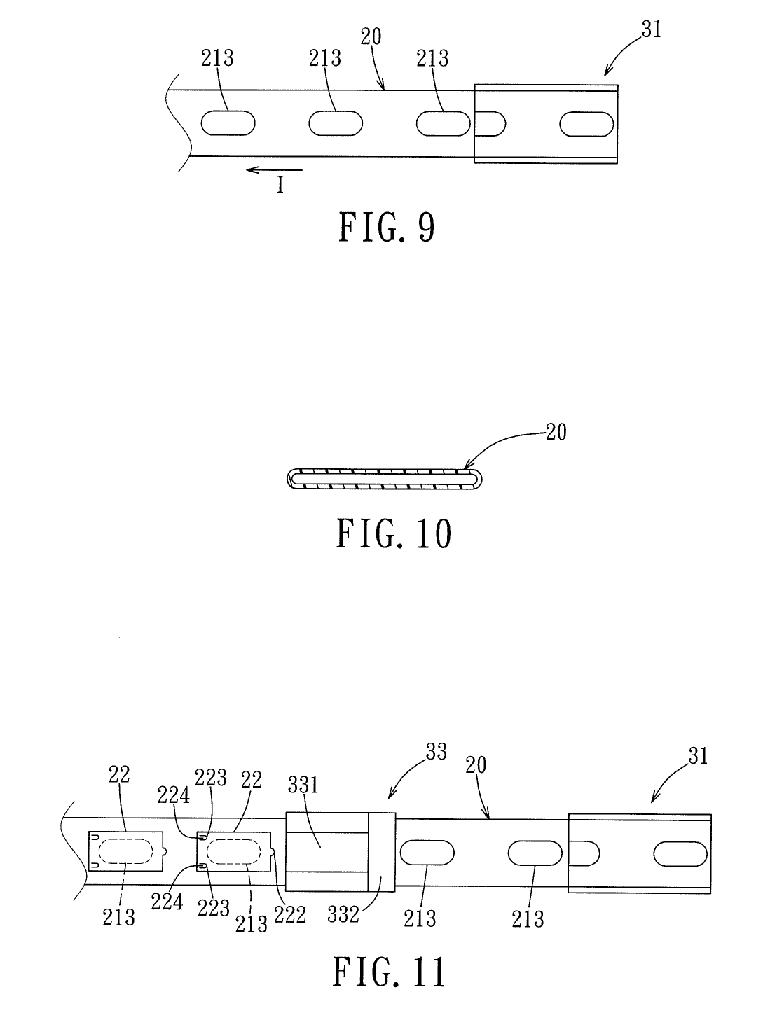

The flexible bag body 21 is made from a flexible seamless tubular body 20 (see FIG. 9) of a heat-weldable material by heat-sealing predetermined portions of the seamless tubular body 20. The flexible bag body 21 defines a receiving space 211 that is adapted to receive the sanitary products 5, and has an access opening 213 formed in a top face thereof and in spatial communication with the receiving space 211, and two sealed ends 214 sealing opposite front and rear ends of the bag body 21.

The resealable flap 22 is connected to the top face of the bag body 21, and has an area larger than that of the access opening 213 so as to seal openably the same. The resealable flap 22 includes an adhesive portion 221 formed on a bottom side thereof and adhered to the top face of the bag body 21, a pull tab 222 projecting forwardly from a front side of the resealable flap 22, and two spaced-apart curved slits 223 proximate to a rear end thereof to define respectively two retaining portions 224. The bag body 21 further includes two spaced-apart vent holes 215 proximate to the rear edge of the resealable flap 22 and in fluid communication with the receiving space 211. The vent holes 215 permit communication between the receiving space 211 and the surrounding air.

To use the tubular packaging bag 2, the resealable flap 22 is pulled upwardly and rearwardly through the pull tab 222 so as to expose the access opening 213, thereby permitting access into the receiving space 211 and to the sanitary products 5. The resealable flap 22 is prevented from separating from the bag body 21 through the retaining portions 224, and is resealed to the bag body 21 after use so as to seal the access opening 213, thereby preventing damping and contamination of the sanitary products 5 inside the receiving space 211.

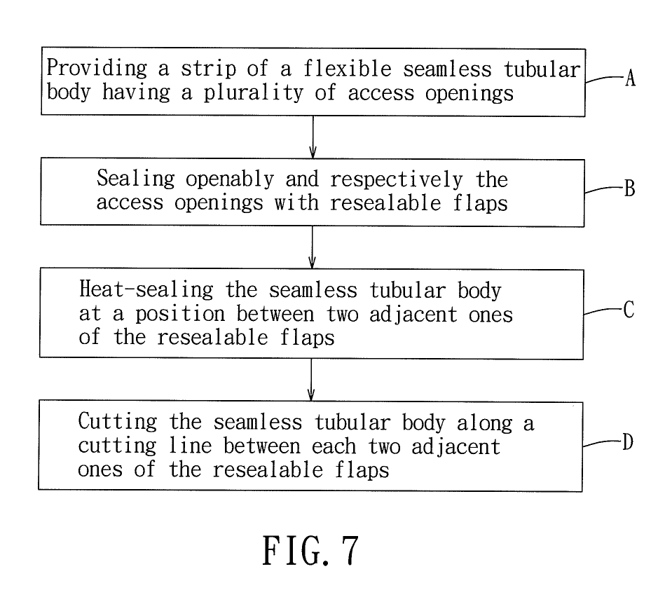

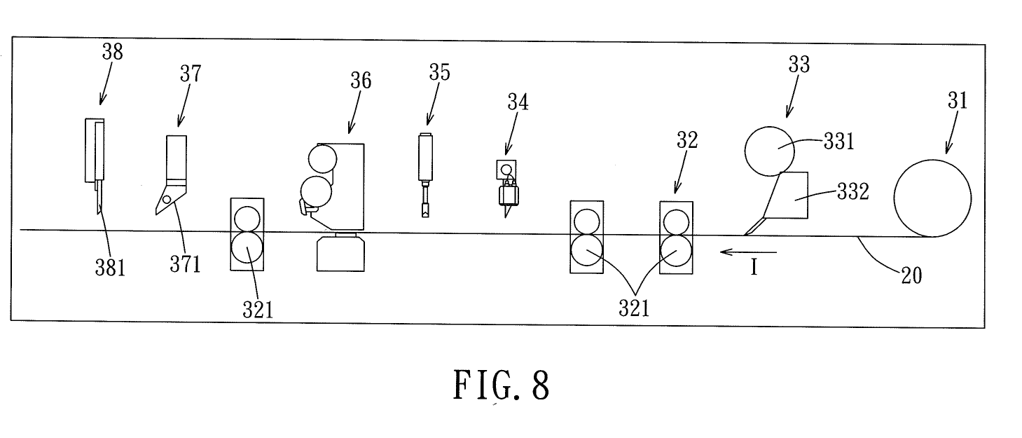

FIG. 7 illustrates a flowchart of a method for making the flexible tubular packaging bag 2 of the preferred embodiment. The method includes steps A to D. FIG. 8 illustrates a system for making the flexible tubular packaging bag 2 of the preferred embodiment. The system includes a supplying roller 31, a conveying device 32, a label-adhering device 33, a detector 34, a punching device 35, an image-forming device 36, a sealing device 37, and a cutting device 38.

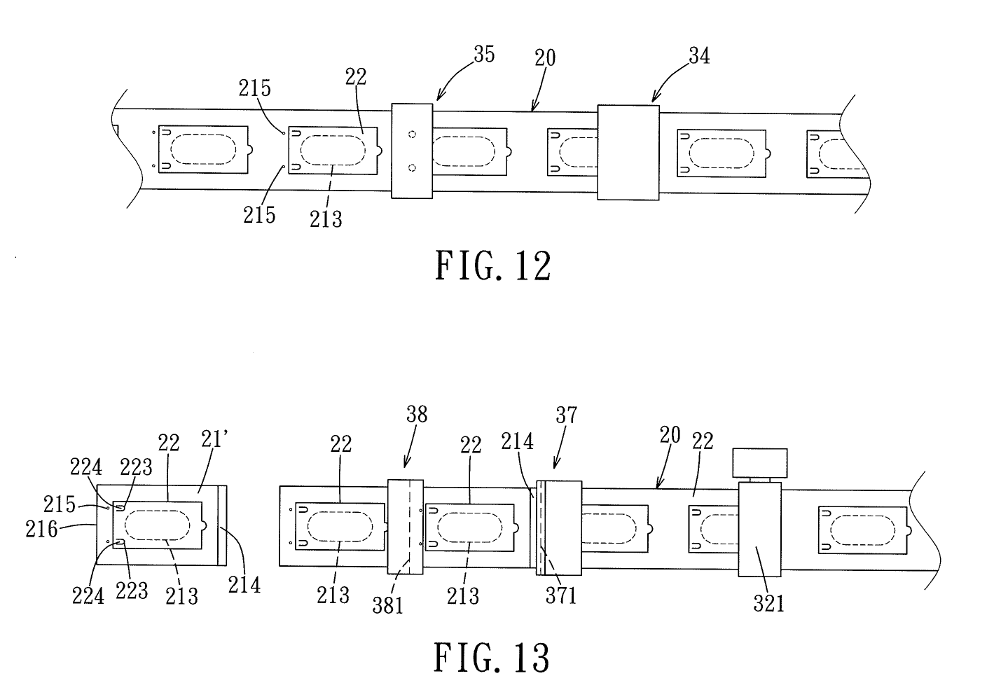

With reference to FIG. 7, in combination with FIG. 8 and FIGS. 9 to 13, in step A, a strip of the flexible seamless tubular body 20 of a heat-weldable material is supplied by the supplying roller 31. The strip of the seamless tubular body 20 has a plurality of the access openings 213 spaced apart from each other and aligned along the length of the strip. The strip of the seamless tubular body 20 is conveyed along a feed direction (I) by the conveying device 32, which includes a plurality of spaced-apart pairs of feed rollers 321.

Step B is carried out in cooperation with the label-adhering device 33 which is disposed downstream of the supplying roller 31. The label-adhering device 33 includes a label-feeding wheel 331 for holding a roll of the resealable flaps 22, and a label-applicator 332 disposed below the label-feeding wheel 331 and above the strip of the seamless tubular body 20. Each resealable flap 22 is structured as described above with reference to FIGS. 4 to 6. The label-applicator 332 receives the resealable flaps 22 fed by the label-feeding wheel 331, and affixes each of the resealable flaps 22 over a respective one of the access openings 213 when the strip of the seamless tubular body 20 is conveyed through the label-applicator 332 so as to seal openably the respective access opening 213.

The detector 34 is disposed rearwardly of the label-adhering device 33 and two pairs of the feed rollers 321. In this embodiment, the detector 34 employs an optical measurement method to detect a position of an adjacent one of the resealable flaps 22 passing therethrough and obtain a corresponding “detected value”. The detector 34 transmits the detected value to the punching device 35, which is disposed downstream of the detector 34, so as to effect punching of the strip of the seamless tubular body 20 with two spaced-apart vent holes 215 between each two adjacent ones of the resealable flaps 22 when the strip of the seamless tubular body 20 passes therethrough. Preferably, the vent holes 215 are provided proximate to the rear end of the corresponding resealable flap 22. The detected value of the detector 34 is also transmitted to the image-forming device 36, which is disposed downstream of the punching device 35, so as to effect pressing of the top face of the corresponding resealable flap 22 and forming a letter, a number, or a pattern on the top face thereof when the seamless tubular body 20 passes therethrough. Air inside the seamless tubular body 20 is driven out via the vent holes 215 when the image-forming device 36 presses the corresponding resealable flap 22 so as to prevent bulging inside the seamless tubular body 20.

Step C is carried out in cooperation with the sealing device 37 which is disposed downstream of the image-forming device 36 and one pair of the feed rollers 321. The sealing device 37 has a heat knife 371 for heat-sealing the strip of the seamless tubular body 20 at a position between two adjacent ones of the resealable flaps 22 so as to form a sealing portion therebetween when the strip of the seamless tubular body 20 passes through the sealing device 37.

Step D is carried out in cooperation with the cutting device 38 which is disposed downstream of the sealing device 37. The cutting device 38 has a cutter 381 for cutting the strip of the seamless tubular body 20 along a cutting line between each two adjacent ones of the resealable flaps 22 when the seamless tubular body 20 passes through the cutting device 38, thereby obtaining semi-finished individual flexible bag bodies 21′. Each of the flexible bag bodies 21′ has an open end 216, and a sealed end 214 opposite to the open end 216 and defined by the sealing portion. Each flexible bag body 21′ is then sent to an operating device (not shown), where the sanitary products 5 (see FIG. 4) can be disposed inside the flexible bag body 21′ via the open end 216. Finally, the open end 216 is sealed through another sealing device (not shown) so as to form another sealed end 214′ (see FIG. 4) which is opposite to the sealed end 214, thereby forming the individual flexible tubular packaging bag 2 of the present invention.

Since the flexible bag body 21 is made from the flexible seamless tubular body 20, in comparison with the making of the conventional flexible tubular packaging bag 1 (see FIG. 1), there is no need to fold and seal together left and right sides of the seamless tubular body 20 so as to form the sealing portion 112 (see FIG. 3), so that the method for making the flexible tubular packaging bag 2 of the present invention is simple. Further, through the presence of the label-adhering device 33, the resealable flaps 22 can be adhered to the flexible bag body 21 through a fast and automatic process, thereby minimizing the production time and cost of the present invention.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. An individual flexible tubular packaging bag for sanitary products, comprising:
a flexible bag body made from a flexible seamless tubular body of a heat-weldable material by heat-sealing two opposite ends of said seamless tubular body, said flexible bag body defining a receiving space that is adapted to receive the sanitary products, and having an access opening in spatial communication with said receiving space; and
a resealable flap connected to said flexible bag body and sealing openably said access opening.

2. The individual flexible tubular packaging bag of claim 1, wherein said bag body further has two spaced-apart vent holes proximate to one end of said resealable flap and in fluid communication with said receiving space.

3. A method for making flexible tubular packaging bags for sanitary products, comprising:
(A) providing a strip of a flexible seamless tubular body of a heat-weldable material, the strip of the flexible seamless tubular body having a plurality of access openings spaced apart from each other and aligned along the length of the strip;
(B) sealing openably and respectively the access openings with resealable flaps;
(C) heat-sealing the seamless tubular body at a position between two adjacent ones of the resealable flaps so as to form a sealing portion therebetween; and
(D) cutting the seamless tubular body along a cutting line between each two adjacent ones of the resealable flaps, thereby obtaining semi-finished individual flexible bag bodies, each of which has an open end, and a sealed end opposite to the open end and defined by the sealing portion.

4. A system for making flexible tubular packaging bags for sanitary products, comprising:
a supplying roller holding a strip of a flexible seamless tubular body of a heat-weldable material, said strip of said flexible seamless tubular body having a plurality of access openings spaced apart from each other and aligned along the length of said strip;
a conveying device to convey said strip of said seamless tubular body supplied by said supplying roller;
a label-adhering device including a roll of resealable flaps and affixing each of said resealable flaps over a respective one of said access openings so as to seal openably the respective one of said access openings;
a sealing device disposed downstream of said label-adhering device and heat-sealing said strip of said seamless tubular body at a position between two adjacent ones of said resealable flaps so as to form a sealing portion therebetween; and
a cutting device disposed downstream of said sealing device and cutting said strip of said seamless tubular body along a cutting line between each two adjacent ones of said resealable flaps so as to form semi-finished individual flexible bag bodies, each of which has an open end, and a sealed end opposite to said open end and defined by said sealing portion.

5. The system of claim 4, wherein said label-adhering device includes a label-feeding wheel to hold said roll of said resealable flaps, and a label-applicator disposed below said feeding wheel and above said strip of said seamless tubular body, said label-applicator receiving said resealable flaps fed by said label-feeding wheel so as to affix each of said resealable flaps over the respective one of said access openings.

6. The system of claim 5, further comprising a detector disposed between said label-adhering device and said sealing device to detect a position of an adjacent one of said resealable flaps passing therethrough, and a punching device disposed downstream of said detector to punch said strip of said seamless tubular body with at least one vent hole between each two adjacent ones of said resealable flaps.

7. The system of claim 6, further comprising an image-forming device disposed downstream of said punching device for forming a pattern on each of said resealable flaps.
